(19) United States
(12) Patent Application Publication
(10) Pub. No.: US 2011/0220122 A1
(43) Pub. Date: Sep. 15, 2011

(54) Human shoulder orthosis assist & method of use

(76) Inventor: Steven Barad, Sacramento, CA (US)

(21) Appl. No.: 12/932,975

(22) Filed: Mar. 9, 2011

Related U.S. Application Data
(60) Provisional application No. 61/340,179, filed on Mar. 15, 2010.

(51) Int. Cl. A61G 15/00; B32B 37/18

(52) U.S. Cl. 128/845; 156/242

(57) ABSTRACT

An orthosis custom molded to the individual user weightlifter to impede shoulder injury when doing bench press lifts, having a molded generally concave top surface foam sheet bonded to a shaped polypropylene resin layer and with a layer of crepe rubber beneath the polypropylene layer. A pair of downwardly depending crepe rubber ribs commence at the upper edge of the device and extend at least halfway down the length of the outer side edges. The space between the ribs laterally is sized to form a close fit to a weight lifters bench.

### RELATIONSHIP TO OTHER APPLICATIONS

This application claims priority from Provisional U.S. Patent Application Ser. No. 61/340,179 filed on Mar. 15, 2010 in the name of Steven Barad.

### FIELD OF INVENTION

This patent pertains to a device for use by weightlifters, be they football, basketball or baseball players, and any other person engaged in weight training, body building, and other types of fitness to develop the chest, who engage in the weightlift, known as the Bench Press.

### BACKGROUND OF THE INVENTION

In the practice of weightlifting, one particular lift is known as the bench press, which has been designated as one of the three power lifts. This lift is used to test the upper both strength of the lifter. To carry out the bench press, the lifter, be it a man or woman, lies down on their back, and lowers a bar bell with lead weights evenly balanced on both sides of the bar, from a weight rest stand to their chest, from the rest. The person then pushes the weight bar up into the air, until the two arms are as straight as possible, such that the elbows lock—that is the weight is held above the supine body. The bench press is used to develop the pectoralis major muscle and other supporting muscles such as anterior deltoids, serratus anterior, coracobrachialis and the triceps. After completing the desired number of the lifts, the person raises the bar bell to the rest.

A variation of the flat bench press is the incline press. Here the shoulders are elevated and the pelvis is lowered. This exercise, works the upper chest muscles and the deltoids.

The problem with bench press lifting is that the exercise has long been associated with problems in the shoulder. Osteolysis of the distal clavicle is a very common problem and can be very painful. Rotator cuff inflammation, impingement and cuff tears can also occur if the lifter is not careful. The problems arise due to the significant strain placed upon the shoulder while performing the series of bench press lifts. The lessening of strain across the acromio-clavicular joint and cuff tendons, would seem to be the way to reduce the risk of degenerative changes

Numerous patents have been issued in an attempt to make life a bit easier for the weightlifter. Some of these are attachments to a standard gym bench, others are to special benches, other patents relate to special pads to be used by the lifter. Of the many patents that have issued for products to aide in weightlifting, mention may be made of:

5,007,633 to Lemire
5,147,260 to Roosevelt
6,899,662 to Gamble et al
5,070,865 to Iams
5,348,523 to Blount
4,621,809 to Pearl and
5,224,956 to Damas et al.

None of these patents comes close to defining an article similar to the one of this patent application either in structure, or mode of use.

The invention accordingly comprises the device which possesses the features, properties, and the selection of components which are amplified in the following detailed disclosure, and the scope of the application of which will be indicated in the appended claims.

### BRIEF DESCRIPTION OF THE FIGURES

FIG. 1 is a top plan view of the device of this invention without one optional attachment pad present.

FIG. 2 is a top plan view similar to FIG. 1, but with the attachment pad in position.

FIG. 3 is an inverted underside view of the attachment pad shown with a hook and loop male pad adhesed in position to facilitate mounting of the attachment pad, at the same location each time.

FIG. 4 is an elevational diagram of this device showing the various layers of its construction.—not to scale

FIG. 5 is a bottom plan view of the device.

FIG. 6 is a top perspective view of the device of this invention without an optional attachment pad attachment area.

FIG. 7 is a top plan view of the device disposed upon a weightlifter's bench.

FIG. 8 is a side elevational view of this device as fitted for one particular user.

FIG. 9 is an elevational view of a weightlifter's bench with the device shown in place for use by a weightlifter.

### SUMMARY OF THE INVENTION

The orthosis device of this invention is a custom molded to each individual, preferably made of a molded foam sheet bonded to a shaped polypropylene resin layer and with a layer of crepe rubber beneath the polypropylene layer. This scapular support is slightly concave, to receive the shoulder area of the user. By custom molded, I mean that the unit must be sized for each individual weight lifter's proportions of the shoulder area, because each individual person is slightly different from the next person not only in dimension, but in pitch, the angle from the vertical that the person differs from 180 degrees when in a standing position. The device is generally concave in cross section, and may be used with or without one or two attachment pads to provide extra cushioning as may be desired. The upper surface may also include a pair of spaced undulations with a valley there between, if the user is one having a large muscular development, be they male or female. Two downward depending spaced vertical ribs run a partial length of the device on the underside of the device's bottom layer, commencing at the top edge of the device. These ribs, be they crepe or another compatible material, are spaced rightwardly of the attachment pad disposition for the left shoulder and spaced leftwardly of the attachment pad location on the right shoulder area. The overall configuration of the device is generally heart shaped but the top edge and bottom edge are each slightly flattened out.

### DESCRIPTION OF THE PREFERRED EMBODIMENT

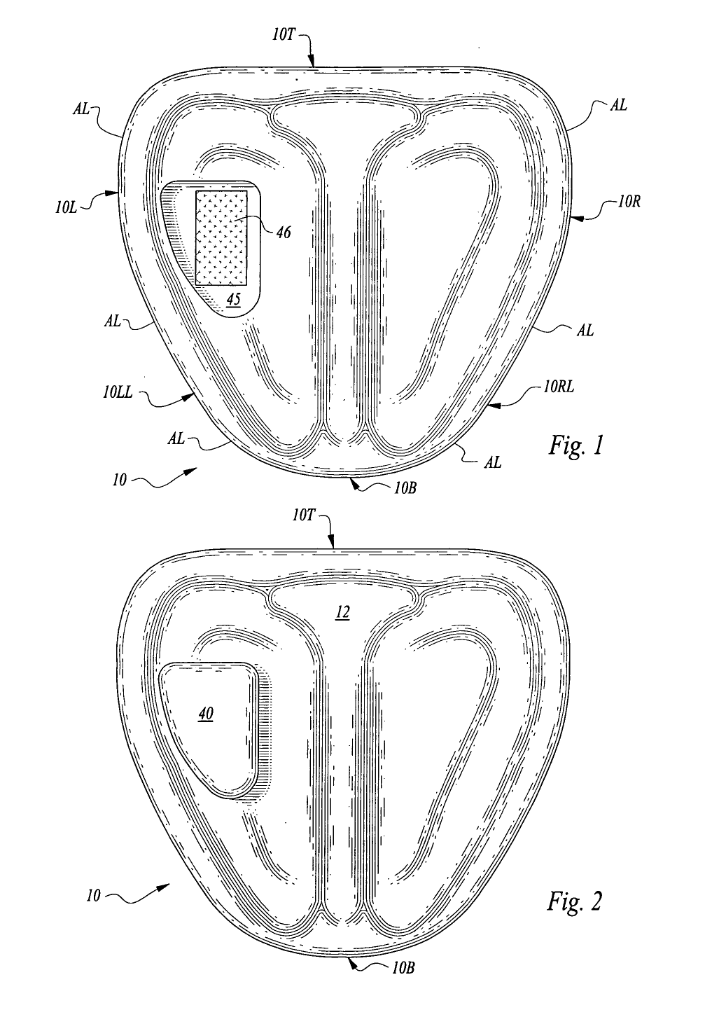

In FIG. 1, the device of this invention 10 is seen with the optional attachment pad 40, for the right shoulder. It must be remembered that viewing the device, is similar to looking in a mirror, in that what appears on the left side of the unit, is utilized on the right side of the back/shoulder area of the user. While only one such pad 10 is seen, it is within the scope of the invention to have two such attachment pads one for each shoulder blade. Note however that in the drawings, references to right and left are made with respect to the eyes of the viewer. Therefore an edge designated 10R will be on the right side of the page.

Device 10 has a top edge, 10T of about ten inches wide with rounded 90 degree edges terminating at left and right side edges 10L and 10R each of which is generally, normal to the top edge for about five inches. At the respective terminii of side edges, there begins a lower side edge, 10LL and 10RL respectively that each depend inwardly for about seven inches, at an arcuate angle to a slightly arcuate base 10B which has an overall extension of about six inches. These dimensions relate to a unit specifically made for one high school male senior of 16 years of age. Other body measurements will vary per individual person, to be more or less than he dimensions recited here. Others may be more or less muscular than this person. The designation AL is to indicate an artificial line of demarcation between edges for ease of description.

Recess 45 designates the area for an attachment pad to be placed for a specific user. The back contour of another user might lace this recess slightly inwardly from the left, or slightly upwardly or downwardly. Every person's back contour and skeleton is different. The device 10 is not flat, but rather is slightly concave again the degree depending on the specific user. On average the depth is about 0.80 to 1.50 inches for most males, depending on the amount of scoliosis if any.

The device herein is not uniformly concave from left edge to right edge. There are twp slight undulations measured at about 4.5 inches from the top edge and they end at about 4.5 inches from the lower edge. They are spaced apart by a valley there between of about 1 to 1.25 inches The purpose of these undulations is to cradle and stabilize the backbone there between.

The thickness of the device when viewed will reveal several fused layers of different compositions, and will be discussed infra.

In FIG. 2, recess 45 is seen at the exact location where the pad 45 is seen in FIG. 1. The recess mimics the shape of the pad but is slightly smaller, such that the pad 40 will be raised up slightly from the surface 12 of device 10.

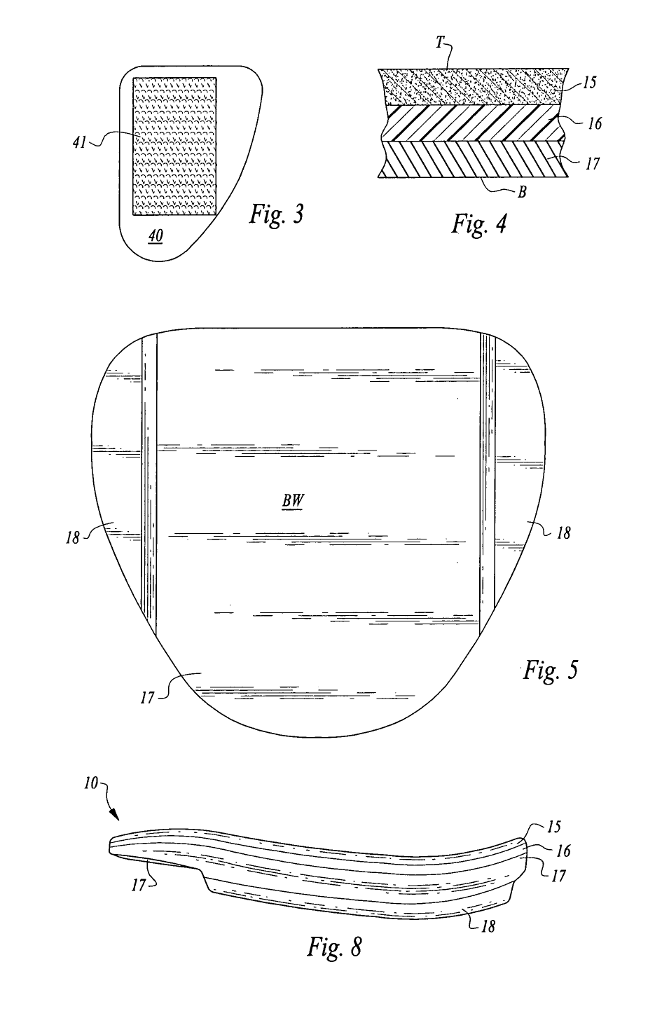

In FIG. 3, the underside of the pad is seen. Note the mirror image as contrasted to the obverse surface thereof in FIG. 2. A hook and loop attachment member 41 is shown attached to the reverse side of the pad 40. Such peel and stick hook and loop or hook and pile, another term of reference used for these attachment members are sold under the trademark Velcro. Attachment member 41 may be of any shape—rectangular here or a round tab may also be employed since such are also available in the marketplace. To secure the pad 40 into place in the recess 45, one must conventionally place a similarly sized attachment member- rectangle- or tab-circular-designated 42, but not seen here at a location within the recess where the element 40 can suitably engage element 42. The use of hook and pile connectors is well understood by the art currently and no further discussion is needed on this topic.

FIG. 4 is an elevational diagram of this device showing the various layers of its construction. Note the uneven location of the layers as shown I FIG. 8, whereas this view is a mere illustration of the plurality of layers. This is due to the overall shape of the middle layer which was cast in plastic to match the person's back and shoulder contour. Device 10 is seen to be made of three layers 15,16, and 17. They are the white foam layer, 15; the cast plastic layer 16, preferably of polypropylene, and a black crepe rubber 17 backer layer.

In FIG. 5, one sees what appears to be a single black layer of foam rubber 17. In point of fact the bottom layer can be applied and then the spacing ribs 18 disposed along the outer edges, can be glued in position. As an alternative, a thicker layer of crepe may be adhesed into position to match the contour of the cast layer 16, and then the area—designated BW for bench width—between the location of the spacing ribs, 18 can be sculpted out by a party familiar with rubber crafting, to leave the area between the ribs open, to a depth of about 0.75 inches. The inward extension of the ribs 18 can vary, to fit the weightlifter's bench to be used by the orthosis owner. This space can vary from about 10 to 13 inches in accordance with the specification of the bench manufacturer. And is designated “BW” in FIG. 5 for bench width.

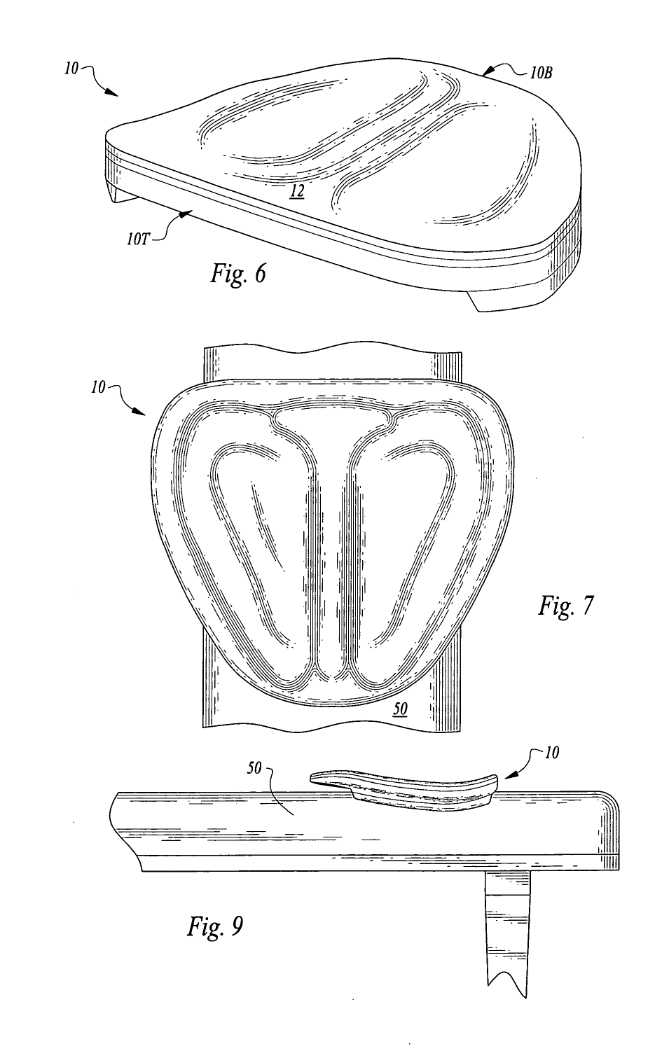

In FIG. 6 a slightly perspective view the top layer of the device 10 and one upstanding rib can also be seen.

In FIG. 7, a top pin view it can seen how the device of this invention fits over a weight lifter's bench 50 and overhangs on each side. The amount of overhang will depend on the back and shoulder size and contour of the particular user.

In FIG. 8, a side view of one of these devices 10, the curvature of the top layer which follows the contour of the back and shoulders of a typical user can be seen as conformed by the casting of the middle layer can be seen.

### Mode of Manufacture

Two modes of manufacture of this device are noted. The first is“the old fashioned way” while the second is considered to be a high tech mode of preparation.

MODE 1

In order to custom mold the unit's middle layer to the shoulders and back of the weight lifter, a series of steps must be carried out prior to the actual molding step.

A. With the person either upright, or lying face down, a large net body stocking is placed on the upper torso.

B. Strips of plaster of Paris, are placed on the posterior of the torso, such that they stick to the stocking net. Alternatively a layer of unhardened plaster can be placed on the body stocking.

C, The patient then lies down on his/her back if not already down, against a firm surface such as a sheet of plywood with arms flexed forward to thereby simulate the position of he hands for a bench press position. The person is urged to keep the scapula maximally retracted, while the plaster sets. The scapula, which is the shoulder blade connects the humerus, (arm bone) with the clavicle, (collar bone).

D. The hardened plaster or plaster of Paris molded material, which is a reverse image of the back and shoulders, is then cut away and measured to make sure that the mold exactly conforms to the dimensions of the upper back. From this negative mold, the positive mold is to be made.

′E. In the molding process, a soft foaming substance, the top layer, is added into the hardened plaster or plaster of Paris, and it assumes the contours of the negative mold, to yield a positive mold.

F, Heat and a vacuum are applied to a sheet of polypropylene to get the plastic layer to adhere to the foam material.

G. After cooling, the dual layer is smothered, and trimmed to size.

H. The crepe layer is glued to the reverse side of the plastic layer, and the area equal to the bench width, BW in FIG. 5 is carved away to yield the ribs. Or in the alternative, two separate ribs can be formed separately conventionally and glued into position. If attached separately any compatible material such as polyurethane elastomer, that will adhere to the crepe maybe utilized for the ribs.

G. After the upstanding ribs are added by either technique, to the basic structure a coating of Aliplast™ ethylene vinyl acetate is applied at least over the top foam layer and preferably over all 3 layers.

The attachment pad 45, discussed above which may be situated under one or both shoulder blades may be formed of fabric filled with non-woven fibers, or a piece of polyurethane foam may be cut to shape for such use. The attachment pad may also be over coated with the ethylene vinyl acetate. Once formed, the attachment pad is removably attached at the desired location by a hook and loop attachment means as shown in FIG. 3. The hook section of the attachment means has an adhesive rear surface, from which a cover layer must be first removed. The loop section also has an adhesive rear surface, which also has a cover layer which is first removed, prior to the placement of the adhesive such that the hook and loop aspects of the attachment means can engage to hold the attachment pad into position.

The discussion now turns to the high tech mode of manufacture of this device. No plaster or plaster of Paris used, and thus a lot of mess is avoided. The high tech process draws upon the original work of Drs. Steven Sprigle and Kao-Chi Chung and others at the University of Virginia back in the 1980s. These doctors used a technique for making custom contoured foam cushions, which technique has been adapted for use in the manufacture of this orthosis. The original researches used an array of spring loaded plungers that were fitted with linear potentiometers. When a person impacts the array of sensors, the amount of displacement at each point was recorded on a computer. The data was used to fabricate custom cushions through the use of a three-axis milling machine, that carved a block of foam to a specific shape for each different person that impacted the sensors.

This technology was later modified to reduce cost, because the electronic shape sensing apparatus, along with the computer interface and software made the technology difficult to implement and thus costly. The modification made was to change the electronic sensing unit into a mechanical measuring device that could be interfaced to a computer using simple paper forms. In the modified version, the person, would sit or lie upon an array of individual plungers whose ending position was to be recorded mechanically in a manner similar to the imprinting of a credit card upon paper,—the modern day version of rubbing a piece of paper with a pencil over a coin, to transfer the image of the penny.

When a plunger is moved, it pushes a cable which cable is attached to aa pointer whose position is recorded when a pressure roller is moved across its surface. The pointer presses against a carbonless form to make a mark that corresponds to the depth of the plunger at that specific location. The imprinted form can be digitized to form a pattern for a computer controlled milling machine. This would prepare the top layer of this device in the same manner as it would cut foam to make a custom pillow. Once the top layer is shaped as needed, the foam would be bonded under pressure and vacuum, to the sheet of polypropylene, which would then have the crepe layer added either with the area for the ribs to be cut out by computer aided cutting tools; or without the spaced ribs 18 which would be added subsequently.

If the user desires to have one or two cushioning attachment pads added to the basic device, the area for each of these can be carved out at the appropriate location on the upper surface of the foam layer preferably after the bonding to the polypropylene layer has taken place, to ensure proper placement.

Whereas the devices currently available for weight lifters who bench press to prevent pain, are a one size fits all, or are non conforming to the skeleton of the user. This product can be made at a reasonable price, is quite portable, weighing in at under one pound, and thus easily transportable from one location to another.

### Mode of Use

When and as the weightlifter is ready to do his/her bench press exercise, the device of this invention is placed on the bench as in FIG. 9. The lifter places the shoulder(s) into position beneath the scapula on the device, face up. Once in position, the lifting exercise can be carried out in a conventional manner.

It has been shown in testing with weight lifters of varying sizes and ages, that use of the device of this invention has significantly reduced the chance for shoulder injury.

Since certain changes may be made in the above device without departing from the scope of the invention herein involved, it is intended that all matter contained in the above description and shown in the accompanying drawings, shall be interpreted as illustrative only and not in a limiting sense

I claim:

1. An orthosis device of a generally heart shaped configuration, custom molded to the individual user weightlifter upper back and torso area, to impede shoulder injury when doing bench press lifts, which device comprises:
a molded generally concave top surface foam sheet bonded to
a shaped polypropylene resin layer and with
a layer of crepe rubber beneath the polypropylene layer, and
a pair of laterally spaced ribs depending downwardly from said crepe rubber layer and running from the top edge of the device about ½ to ⅔rds the length of the device.

2. The device of claim 1 wherein at least the top and middle layers are after coated with ethylene vinyl acetate.

3. The device of claim 1 including at least one recess for an attachment pad.

4. The device of claim 3 further including an attachment pad for each recess present to add extra cushioning.

5. The device of claim 1 including two recesses for an attachment pad, one pad to add comfort to each shoulder blade.

6. The device of claim 5 further including an attachment pad for each recess present to add extra cushioning.

7. The device of claim 1 wherein the spacing between the ribs varies form about 10 inches to about 12 inches.

8. An orthosis device of a generally heart shaped configuration, custom molded to the individual user weightlifter upper back and torso area, to impede shoulder injury when doing bench press lifts, which device comprises:
a molded generally concave top surface foam sheet bonded to
a shaped polypropylene resin layer and with
a layer of crepe rubber beneath the polypropylene layer, and
a pair of laterally spaced ribs depending downwardly from said crepe rubber layer and running from the top edge of the device about ½ to ⅔rds the length of the device
including at least one recess for an attachment pad and
further including an attachment pad for each recess present to add extra cushioning to the shoulder blade.

9. The device of claim 8 wherein at least the top and middle layers are after coated with ethylene vinyl acetate.

10. The method for impeding injury to the shoulders and back of weight lifters doing bench presses, which comprises making a new orthosis:
a) custom molding a layer of foam to conform to the shoulders and upper back of the potential user,
b) bonding under vacuum and pressure the upper surface of a layer of polypropylene to the foam, to conform the polypropylene to the foam,
c) adhesing a layer of crepe rubber to the lower surface of the polypropylene, and
d) placing the device on a weightlifter bench,
e) reclining on the bench with the shoulder area within the orthosis and
f) carrying out one's exercise program.

11. The method of claim 10 further including the step of sculpting out part of the crepe to create a pair of spaced ribs.

12. The method of claim 10 further including the step of adhesing a pair of spaced pref-formed ribs commencing at the top edge of the crepe layer on the two side edges of the underside of the crepe layer with a space there between.

13. The method of making a new orthosis for weight lifters who do bench presses, which comprises:
a) custom molding a layer of foam to conform to the shoulders and upper back of the potential user,
b) bonding under vacuum and pressure the upper surface of a layer of polypropylene to the foam,
c) adhesing a layer of crepe rubber to the lower surface of the polypropylene.

14. The method of claim 10 further including the step of sculpting out part of the crepe to create a pair of spaced ribs.

15. The method claim 13 further including the step of adhesing a pair of ribs along the outer edges of the underside of the crepe layer on the opposite edges thereof along the length of the device.
